(19) United States
(12) Patent Application Publication
(10) Pub. No.: US 2008/0130528 A1
(43) Pub. Date: Jun. 5, 2008

(54) SYSTEM AND METHOD FOR BARGING IN A HALF-DUPLEX COMMUNICATION SYSTEM

(75) Inventor: Anuraj Kunnummel Ennai, Bangalore (IN)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/737,589

(22) Filed: Apr. 19, 2007

Related U.S. Application Data
(60) Provisional application No. 60/868,123, filed on Dec. 1, 2006.

(51) Int. Cl. H04B 3/36

(52) U.S. Cl. 370/293; 370/401

(57) ABSTRACT

A system and method for barging in a half-duplex communication system is disclosed. A system that incorporates teachings of the present disclosure may include, for example, a communication device having a controller element that manages a wireless transceiver and audio system, transmits a barge-in request while an Interactive Media Response system (IMR) is in control of a half-duplex communication session, and receives control of the half-duplex communication session in response to the IMR yielding control of said half-duplex communication session. Additional embodiments are disclosed.

### CROSS REFERENCE TO RELATED APPLICATIONS

This application claims the benefit of U.S. Provisional Patent Application No. 60/868,123, filed Dec. 1, 2006, the entire contents of which are incorporated by reference herein.

### FIELD OF THE DISCLOSURE

The present disclosure relates generally to communication systems, and more specifically to a system and method for barging in a half-duplex communication system.

### BACKGROUND

Push-To-Talk over Cellular (PoC) and Push-to-eXperience (PTX) are half-duplex communication technologies that can provide voice, video and/or data services to consumers. Presently, when a consumer using such services wants to take control of a half-duplex communication session from another party or from an interactive media system (such as an interactive voice response system or IVR) in control of the half-duplex channel, the end user must wait for the other party or system to relinquish control of the channel in order to respond or begin the exchange of messages on said channel. This method of communication may not always be convenient to a consumer.

A need therefore arises for a system and method for barging in a half-duplex communication system.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate the embodiments and explain various principles and advantages, in accordance with the present disclosure.

FIG. 1 depicts an exemplary block diagram of a communication system;

FIG. 2 depicts an exemplary flowchart of a method operating in the communication system; and

FIG. 3 is a diagrammatic representation of a machine in the form of a computer system within which a set of instructions, when executed, may cause the machine to perform any one or more of the methodologies discussed herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION

The specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Embodiments in accordance with the present disclosure provide a system and method for barging in a half-duplex communication system.

In a first embodiment of the present disclosure, a method can have the steps of receiving a barge-in request from a first computing terminal while a second computing terminal is in control of a half-duplex communication session, and yielding control of the half-duplex communication session to the first computing terminal in response to the barge-in request.

In a second embodiment of the present disclosure, an Interactive Media Response system (IMR) can have a controller element that receives a barge-in request from a computing terminal while the IMR is in control of a half-duplex communication session, and yields control of the half-duplex communication session to the computing terminal in response to the barge-in request.

In a third embodiment of the present disclosure, a communication device can have a controller element that manages a wireless transceiver and audio system, transmits a barge-in request while an Interactive Media Response system (IMR) is in control of a half-duplex communication session, and receives control of the half-duplex communication session in response to the IMR yielding control of said half-duplex communication session.

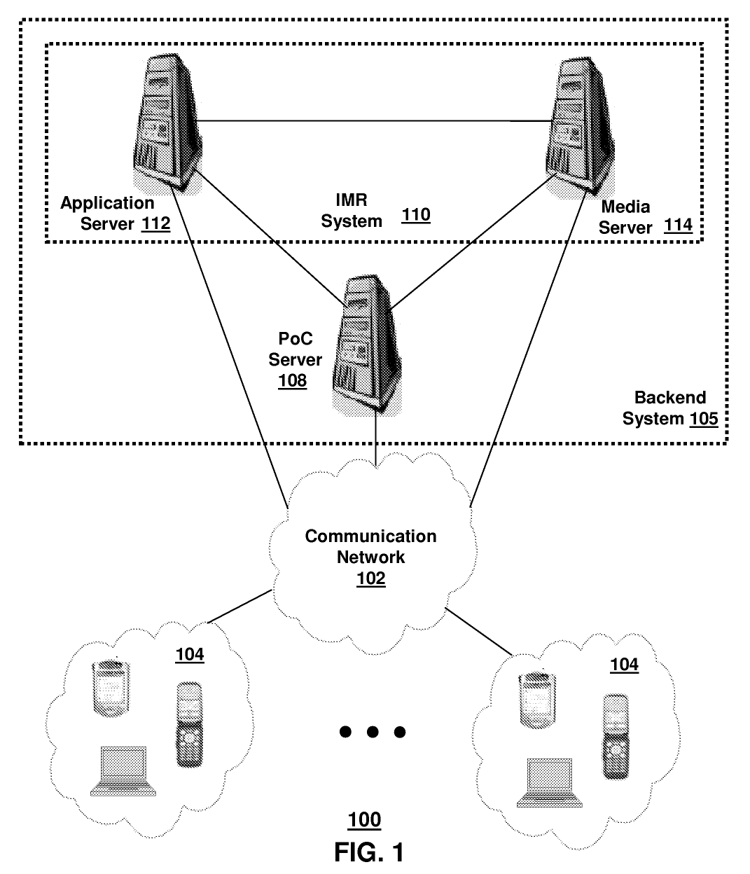

FIG. 1 depicts an exemplary communication system 100. The communication system 100 can comprise a communication network 102 supplying communication services to a number of computing devices 104 and a backend computing system 105 that supports half-duplex single or multimedia services. The computing devices 104 can be represented by a number of computing terminals able to support communications with other terminals such as a cell phone, a PDA (Personal Digital Assistant), a laptop computer, or other suitable computing devices. The backend computing system 105 can comprise a Push-to-talk over Cellular (PoC) 108 server that manages half-duplex communications. The PoC 108 can operate in cooperation with an Interactive Media Response system (IMR) 110 that presents Push-To-Talk (PTT) and/or Push-To-eXperience (PTX) services to consumers of the computing devices 104.

PTX services can include without limitation a Push-To-View service, which enables a user to quickly share pictures and speak to them in real time, a Push-To-Video service which can enable users to share video streams or clips with buddies, a Push-To-email service which can enable a user to send an email with a voice mail attachment, a Push-To-Find service which can take advantage of GPS technology to offer location sharing and real-time navigation, and a Push-To-Ask service where a consumer can use voice responses to access news and other relevant information.

To support PTT and/or PTX services, the IMR system 110 can utilize an application server 112 and a media server 114. The application server 112 can be programmed to detect PTT and PTX requests submitted by the computing terminals 104 and manage a media server 114 supplying media services to said terminals accordingly. The media server 114 can be programmed with common technologies to support the aforementioned PTX services. The media server 114 can also operate as an Interactive Voice Response system (IVR) utilizing a Voice eXtensible Markup Language (VoiceXML). As an IVR, the media server 114 can interact with users of the computing terminals 104 utilizing voice presentation and voice recognition technologies that operate according to a given algorithm defined by, for example, a call processing flow that extracts voice prompts from a call flow database.

It would be appreciated that IMR 110 as described can be integrated into a centralized computing system or decentralized into less or more than the number of computing systems illustrated in FIG. 1. The same assertions can be made of the PoC 108. Similarly, the IMR 110 and the PoC 108 can be an integral part of each other. Accordingly, it would be evident to one of ordinary skill in the art that said systems can be in whole or in part rearranged, modified, or otherwise organized in a manner different from the illustration of FIG. 1 without departing from the scope of the present disclosure.

Network elements of the communication system 100 (i.e., the communication network 102 and the backend system 105) can be architected to support circuit and/or packet switched technologies. For example, portions of the communication system 100 can operate as a Public Switched Telephone Network (PSTN) utilizing SS7 as its signaling system. Other portions of the communication system 100 can be architected according to an IP Multimedia Subsystem (IMS) architecture utilizing a Session Initiation Protocol (SIP) or derivatives thereof to support multiple embodiments of IP communications (e.g., Voice over IP, video, and data). Any number of wireless communication protocols can also be supported by all or a portion of the network elements of the communication system 100 (e.g., CDMA, GSM, UMTS, EVDO, etc.).

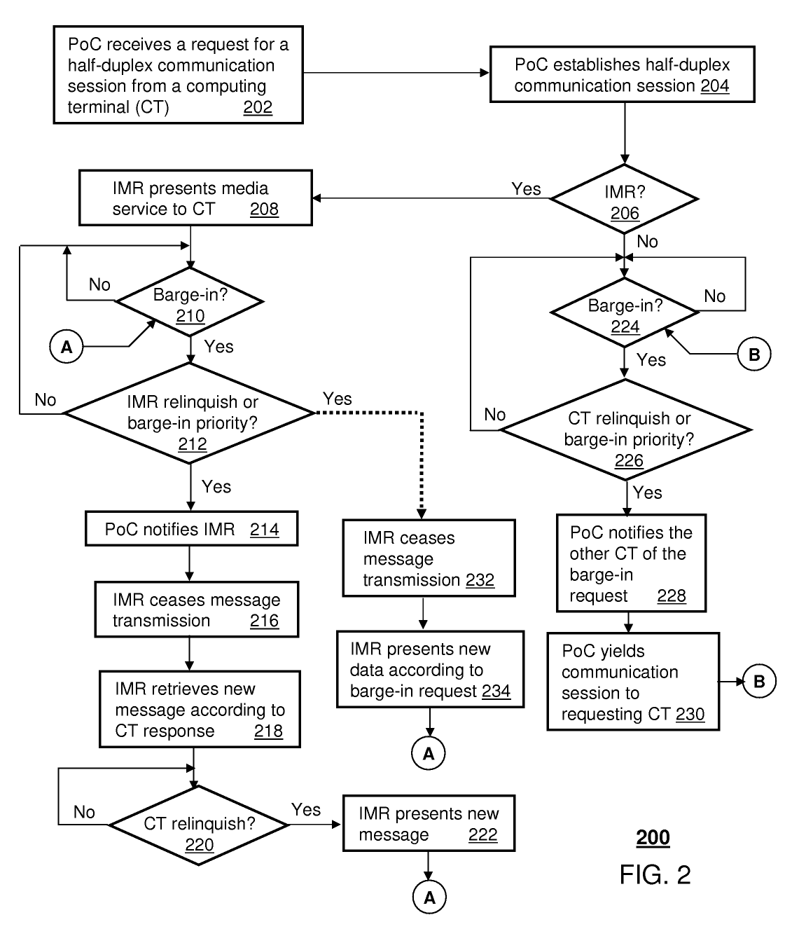

FIG. 2 depicts a method 200 operating in the communication system 100. Method 200 can be utilized for establishing half-duplex communications between computing terminals 104 and/or between computing terminals 104 and the backend system 105 (which itself can be considered a computing terminal) when engaged in PTT, PTX or like applications. With these principles in mind, method 200 begins with step 202 in which the PoC 108 receives a request for a half-duplex communication session from a computing terminal (CT) 104. This request can be triggered by, for example, a PTT or PTX button on the CT 104 or by other suitable means. The PoC 108 in response establishes in step 204 the half-duplex communication session as requested by the CT 104. If in step 206 the communication session is intended between a CT 104 and the IMR 110, then method 200 proceeds to step 208 where the IMR presents a requested media service to the CT. Otherwise, the half-duplex communication session would be intended for a CT 104 to CT engagement in which case method 200 proceeds to step 224 where the PoC 108 monitors a barge-in request from either of the CTs.

Assuming an IMR 110 exchange has been triggered, method 200 proceeds to step 210 whereby barge-in requests from the CT 104 are monitored. The barge-in requests can be monitored by the PoC 108 or the IMR 110 (by way of, for example, the application server 112). For the time being it will be assumed that the PoC 108 monitors and manages the barge-in request. When a barge-in request is detected in step 210, the PoC 108 (or IMR 110) proceeds to step 212 to determine if the IMR has already relinquished control of the half-duplex communication session, or if the barge-in request of the CT has a higher priority than the IMR. If the channel has not been relinquished and the CT 104 does not have a higher barge-in priority than the IMR 110, the barge-in request is rejected. If on the other hand the channel has been relinquished by the IMR 110 or the barge-in request is of higher priority than the IMR, the PoC 108 notifies the IMR 110 in step 214 to yield control of the half-duplex channel to the CT 104. The IMR 110 in response ceases in step 216 message transmission to the CT 104 (if it has not already relinquished control of the half-duplex channel) and retrieves in step 218 a new message from a call flow database according to a response message received from the CT 104. The IMR 110 presents this new message in step 222 once it detects in step 220 that the CT 104 has relinquished the half-duplex channel.

Steps 214-222 can be broken down further as follows. In step 214 the PoC 108 can notify the application server 112 of the barge-in request which notifies the media server 114 to cease message transmission in step 216. After the media server 114 relinquishes control, it begins to monitor for CT responses (e.g., voice, data, Dual Tone Multi-Frequency or DTMF code signals, or like signaling information). From a CT response, the media server 114 selects in step 218 an appropriate response from its call flow database. Once the CT 104 relinquishes control of the half-duplex channel in step 220, the media server 114 resumes control of said channel and presents in step 222 the message retrieved in step 218. As noted earlier, the application server 112 can be utilized in place of the PoC 108 to monitor the barge-in requests. In this embodiment, the PoC 108 can be programmed to manage control of the half-duplex channel according to release tokens supplied by either the CT 104 or the media server 114. The process just described is repeated at step 210 until the half-duplex communication session is terminated by the CT 104 or the IMR 110.

In an alternative embodiment, the IMR 110 proceeds from step 212 to step 232 when the barge-in request is of higher priority or the IMR has relinquished the channel and said barge-in request includes one or more data elements that are instructive to the IMR and/or provides user preferences for applications. In step 232 the IMR 110 ceases message transmission, and presents in step 234 new data to the CT 104. The new data can be a new message from a call flow data base, or media data associated with a media service supplied by the IMR 110. The media data can be selected according to user application preferences if supplied in the barge-in request.

Referring back to step 206, method 200 can proceed to step 224 for CT 104 to CT communications. In this embodiment, the PoC 108 monitors in steps 224-226 barge-in requests from either CT 104 in a manner similar to what was described for steps 210-212. Thus, when a CT 104 submits a barge-in request with a higher priority than the other CT in control of the channel, or the other CT has relinquished control before the barge-in request arrives, the PoC 108 proceeds to step 228 and notifies the other CT of the barge-in request and instructs it to yield control if it hasn't already. The PoC 108 in step 230 yields control of the half-duplex communication session to the requesting CT. The foregoing process continues from step 224 until the half-duplex communication session is terminated by either CT 104.

The embodiments of method 200 disclose a useful barge-in approach to half-duplex communications. By establishing barge-in priorities between computing terminals, a more efficient means is disclosed for the exchange half-duplex communications. For example, when an end user of a CT 104 is engaged in a half-duplex voice session with an IVR over a half-duplex channel, said user can skip menus, interrupt the IVR, or the like by depressing a PTT button or entering a key sequence that generates a DTMF code that is interpreted by the IVR to rapidly navigate through the IVR's call flow structure. In prior art systems that do not provide a barge-in priority, the end user would have to wait for each IVR voice prompt to be fully transmitted so that the IVR can relinquish control of the half-duplex channel.

It should be noted that though a priority setting for barge-in requests has been disclosed, an alternative embodiment can be used in which barge-in requests have equal priority for computing terminals. In this embodiment, a barge-in request always interrupts a CT 104 in control of a half-duplex channel. When this happens, the relinquishing CT 104 can regain control of the channel by resubmitting a barge-in request (e.g., pressing again the PTT button). Under such circumstances the end users of the CTs 104 would have to rely on each other to maintain an interruption rate that does not lead to unintelligible communications. In a case where one of the CTs 104 is an IMR 110, a higher barge-in priority can be given to an end user of the CT with minimal risk of creating unintelligible communications with the IMR.

Upon reviewing the present disclosure, it would be evident to an artisan with ordinary skill in the art that the aforementioned embodiments can be modified, reduced, or enhanced without departing from the scope and spirit of the claims described below. As just noted, different barge-in priorities schemes can be applied to method 200. Also noted, the tasks described by method 200 can be reassigned between computing devices illustrated in FIG. 1 without affecting the results disclosed herein. These are but a few examples of modifications that can be applied to the present disclosure without departing from the scope of the claims stated below. Accordingly, the reader is directed to the claims section for a fuller understanding of the breadth and scope of the present disclosure.

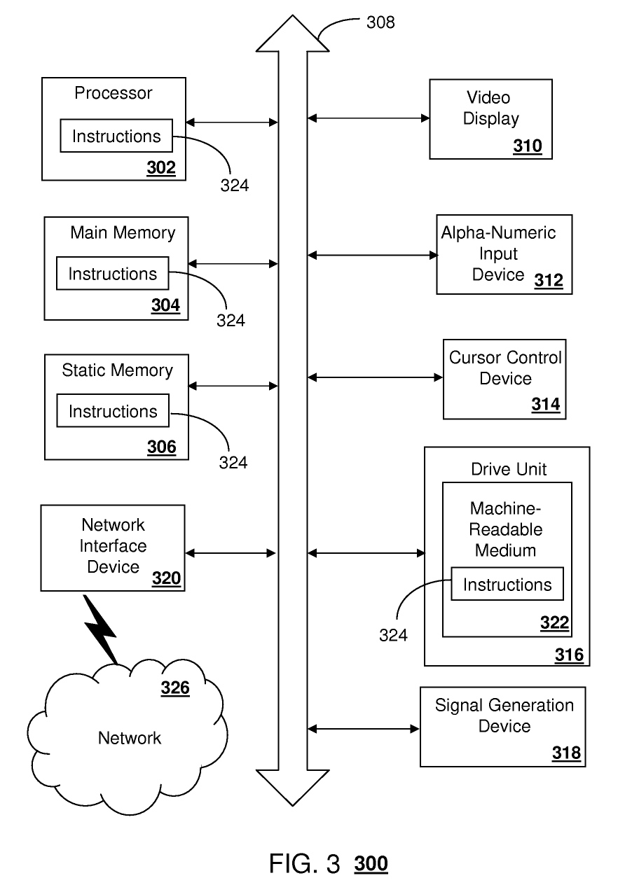

FIG. 3 is a diagrammatic representation of a machine in the form of a computer system 300 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 300 may include a processor 302 (e.g., a central processing unit (CPU), a graphics processing unit (GPU, or both), a main memory 304 and a static memory 306, which communicate with each other via a bus 308. The computer system 300 may further include a video display unit 310 (e.g., a liquid crystal display (LCD), a flat panel, a solid state display, or a cathode ray tube (CRT)). The computer system 300 may include an input device 312 (e.g., a keyboard), a cursor control device 314 (e.g., a mouse), a disk drive unit 316, a signal generation device 318 (e.g., a speaker or remote control) and a network interface device 320.

The disk drive unit 316 may include a machine-readable medium 322 on which is stored one or more sets of instructions (e.g., software 324) embodying any one or more of the methodologies or functions described herein, including those methods illustrated above. The instructions 324 may also reside, completely or at least partially, within the main memory 304, the static memory 306, and/or within the processor 302 during execution thereof by the computer system 300. The main memory 304 and the processor 302 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 324, or that which receives and executes instructions 324 from a propagated signal so that a device connected to a network environment 326 can send or receive voice, video or data, and to communicate over the network 326 using the instructions 324. The instructions 324 may further be transmitted or received over a network 326 via the network interface device 320.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method, comprising:
receiving a barge-in request from a first computing terminal while a second computing terminal is in control of a half-duplex communication session; and
yielding control of the half-duplex communication session to the first computing terminal in response to the barge-in request.

2. The method of claim 1, wherein the first computing terminal has a barge-in priority higher than the second computing terminal, wherein the half-duplex communication session comprises at least one among voice, video and data exchanges, and wherein the barge-in request of the first computing terminal can selectively or collectively barge-in to the voice, video and data exchanges.

3. The method of claim 1, wherein the barge-in request comprises one or more data elements, wherein the second computing terminal comprises an Interactive Media Response system (IMR), and wherein the method comprises:
informing the IMR of the one or more data elements; and
the IMR managing transmission of data directed to the first computing terminal according to the one or more data elements.

4. The method of claim 3, wherein the data elements correspond to at least one among one or more instructions for the IMR, and one or more application preferences.

5. The method of claim 1, wherein the second computing terminal comprises an Interactive Media Response system (IMR), and wherein the method comprises instructing the IMR to cease transmission of a message directed to the first computing terminal.

6. The method of claim 5, comprising the IMR transitioning to a new message according to a response message received from the first computing terminal while the first computing terminal is in control of the half-duplex communication session.

7. The method of claim 6, comprising the IMR retrieving the new message from a call flow database according to the response message, and presenting said new message to the first computing terminal once the first computing terminal relinquishes control of the half-duplex communication session.

8. The method of claim 6, wherein the response message and messages presented by the IMR comprise at least one among voice, video and data messages.

9. The method of claim 6, wherein the response message comprises a data code, and wherein the method comprises the IMR retrieving the new message from a call flow database according to the data code, and presenting said new message to the first computing terminal once the first computing terminal relinquishes control of the half-duplex communication session.

10. The method of claim 9, wherein the data code corresponds to one or more Dual Tone Multi-Frequency (DTMF) signals.

11. The method of claim 1, wherein the half-duplex communication session comprises at least one among voice, video and data submitted by at least one among the first and second computing terminals, and wherein at least one among the computing terminals comprises a wireless mobile communication device.

12. An Interactive Media Response system (IMR), comprising a controller element that receives a barge-in request from a computing terminal while the IMR is in control of a half-duplex communication session, and yields control of the half-duplex communication session to the computing terminal in response to the barge-in request.

13. The IMR of claim 12, wherein the controller element ceases transmission of a message directed to the computing terminal in response to the barge-in request.

14. The IMR of claim 13 wherein the controller element transitions to a new message according to a response message received from the computing terminal while the computing terminal is in control of the half-duplex communication session.

15. The IMR of claim 14 wherein the controller element retrieves the new message from a call flow database according to the response message, and presents said new message to the computing terminal once the computing terminal relinquishes control of the half-duplex communication session, and wherein the response message and messages presented by the IMR comprise at least one among voice, video and data messages.

16. The IMR of claim 14 wherein the response message comprises a data code, and wherein the controller element retrieves the new message from a call flow database according to the data code, and presents said new message to the computing terminal once the computing terminal relinquishes control of the half-duplex communication session.

17. The IMR of claim 12, wherein the computing terminal has a barge-in priority higher than the IMR, wherein the IMR comprises an Interactive Voice Response system (IVR) operating according to a Voice eXtensible Markup Language (VoiceXML), and wherein the computing terminal comprises a wireless mobile communication device.

18. A communication device, comprising a controller element that manages a wireless transceiver and audio system, transmits a barge-in request while an Interactive Media Response system (IMR) is in control of a half-duplex communication session, and receives control of the half-duplex communication session in response to the IMR yielding control of said half-duplex communication session.

19. The communication device of claim 18, wherein the wireless transceiver has barge-in priority higher than the IMR, wherein a controller element manages an exchange wireless half-duplex messages with the IMR by way of a communication system, and wherein said half-duplex messages comprise at least one among voice, video and data messages.
